(19) United States
(12) Patent Application Publication
(10) Pub. No.: US 2007/0205864 A1
(43) Pub. Date: Sep. 6, 2007

(54) Secure radio frequency identification system

(75) Inventors: Carlo Mutti, Origlio (CH); Enrico Malacarne, Duebendorf (CH)

Correspondence Address: AKERMAN SENTERFITT, P.O. BOX 3188, WEST PALM BEACH, FL, 33402-3188, US

(73) Assignee: Datamars S.A., Bedano-Lugano (CH)

(21) Appl. No.: 11/356,890

(22) Filed: Feb. 17, 2006

(51) Int. Cl. H04Q 5/22

(52) U.S. Cl. 340/10.1; 340/572.1; 340/10.3; 340/10.51; 340/5.74

(57) ABSTRACT

Radio frequency identification (RFID) system comprising a read-write device 1, including a memory unit 3 for storing a plurality of basic opcodes ba-op, an RFID tag 5, including a memory unit 8 for storing data item and a plurality of opcodes cr-op; the basic opcodes ba-op and opcodes cr-op drives the communication between the read-write device 1 and the RFID tag 5 according to a standard air interface. The memory unit 3 comprises a mapping function fx for transforming said basic operands ba-op in said operands cr-op; the opcodes cr-op are in crypted format and the mapping function fx authorises the communicative connection between the RFID tag 5 and the read-write device 1. The memory unit 3 also comprises a plurality of optional operating codes opt-op and the memory unit 8 also comprises a plurality of further optional operating codes opt-cr-op in crypted format. The mapping function fx also transforms the optional operating codes opt-op in such further optional operating codes opt-cr-op. The mapping function fx authorises the communicative connection between the RFID tag 5 and the read-write device 1.

### FIELD OF APPLICATION

This invention relates to a secure radio frequency identification (RFID) system comprising a read-write device for receiving and transmitting RF waves from and to an RFID tag. More particularly this invention relates to an RFID system of the type indicated above and comprising:

a read-write device, including a memory unit for storing a plurality of basic operating codes;

an RFID tag, including a memory unit for storing data item, for example the unique identifier (UID), and a plurality of further operating codes;
said basic operating (or command) codes and further operating codes driving the communication between said read-write device and said RFID tag according to a standard air interface.

The invention relates to an RFID system complying with some communication standards for receiving and transmitting RF signals, for example the standards defined by the International Organization for Standardisation (ISO) 18000-2 and ISO 18000-3.

### PRIOR ART

As it is well known, an RFID system comprises a read-write device for reading and writing data stored inside an RFID tag.

Generally speaking an RFID tag is a small sized electronic device including a memory and used to identify items in a wide range of applications, for instance vehicles, clothes in warehouses, animals, livestock, shop items, ID cards or laundries, proximity cards to control physical access, automated toll payment, etc.

With reference to FIG. 1, an RFID system including a conventional read-write device 1 and an RFID tag 5 is globally indicated with 10. More particularly, the read-write device 1 comprises an antenna 2, for receiving and transmitting RF waves from and to the RFID tag 5, and a memory unit 3. If the read-write device 1 is re-programmable the memory unit 3 is a read-write memory unit, otherwise it is a read-only memory unit.

The RFID tag 5 comprises a tag-antenna 6 and a microchip 7, including a memory unit 8 and an electronic processing unit 9, for computing purposes. More particularly, the memory unit 8 stores data associated to an item to be tagged and a plurality of basic and/or optional command codes for managing the communication with the read-write device 1. Those operation (or command) codes correspond to simple or complex commands and/or operating instructions and will be identified with the term opcodes in the following lines.

The micro chip 7 inside the RFID tag 5 is designed to minimise its cost and size: the memory unit 8 is small sized, the electronic processing unit 9 provides only low computational power and no one on-board power units are provided for activating the micro chip 7.

In fact, the microchip 7 is powered by a magnetic field generated by the read-write device 1 and joining with the tag-antenna 6 on the RFID tag 5, generally according to a standard air interface, as instance the ISO 18000-3.

More particularly, the standard ISO provides basic opcodes ba-op and a number of optional opcodes opt-op for driving the communication between the read-write device 1 and the RFID tag 5. For example, we have the opcodes “inventory”, “stay quiet”, “write single block”, “multiple read block”, “reset to ready”, “toggle EAS”, “quiet storage”, “login”, etc. as schematically represented in the table shown in FIG. 2.

The basic opcodes ba-op and, if that is the case, the optional opcodes opt-op are written in the memory unit 8 by a manufacturer M of the micro chip 7, more particularly inside one or more blocks 11 of the memory unit 8.

The same basic opcodes ba-op and, if that is the case, the optional opcodes opt-op are stored inside the read-write memory unit 3 of the read-write device 1.

When the read-write device 1 issues a communication signal by sending a basic or an optional opcode ba-op or opt-op to the RFID tag 5, the corresponding operation is performed by the RFID tag 5.

The several varieties of RFID tags 5 currently in use, as well as their wider and wider applications, require that such communication between the read-write device 1 and the RFID tag 5 is secure, especially for guaranteeing the privacy of the information stored inside the tag memory unit 8, authenticating the read-write device 1 that access to such information.

In fact, the impending ubiquity of RFID tags 5 poses a potentially widespread threat to consumer privacy: if an RFID tag 5 is easily readable through the basic and optional opcodes ba-op and opt-op by any kind of read-write device 1, the corresponding tagged item could be subject to indiscriminate physical tracking as would be for their owner.

To provide a good protection, RFID tags 5 may be designed to execute advanced cryptography and security functions, for example based on symmetric or asymmetric algorithms. With advanced cryptography protection, the RFID tag 5 may be put in communication with the read-write device 1 only if this last is authenticated and authorised on the basis of a private/public key system.

Well known approaches provide security with the use of cryptography algorithms with secret keys; however, advanced cryptography on RFID systems has known drawbacks.

In fact, security functions require an electronic processing unit 9 able to perform computationally intensive cryptographic operations and a corresponding well endowed memory unit 8, rendering the RFID tag 5 too expensive for the largest part of the today applications.

Moreover, advanced cryptography techniques often require complicated key handling and computing, damaging the reading speed of the read-write device 1 and the response time of the RFID tag 5.

Other known techniques may handle the security of the communication between the read-write device 1 and the RFID tag 5, without reaching the level of advanced cryptography, for example combining additional information, such as a processor serial number, a manufacturer ID or the cyclic redundancy checksum (CRC), with the basic and option opcodes ba-op, opt-op.

In this respect the European Patent EP 0 982 688, in the name of Datamars SA, discloses a method based on a processor serial number that makes the combination of the opcode and the processor serial number almost unique, as long as respective processor manufacturer will never produce two identical serial numbers.

These techniques uses a database with limited access to recognise and validate the unique identifier of the RFID tag 5, but there is a drawback due to the fact that those techniques need to read long serial numbers, for executing operations and consequently reduces the security of the RFID system 10.

The problem at the base of the present invention is that of providing a secure RFID system able to protect the communication between a read-write device and a low-cost RFID tag equipped with small storage capacity and low computational power, while complying with a standard ISO communication; such an RFID system being able to preserve the reading speed of the read-write device without overcharging the RFID tag with computationally intensive and advanced cryptographic operations.

### SUMMARY OF THE INVENTION

A first embodiment of the invention relates to an RFID system as previously indicated and defined by the characterising portion of the enclosed claim 1.

The features and advantages of the system according to the invention will be apparent from the following description of an embodiment thereof, given by way of non-limitative examples with reference to the accompanying drawings.

### BRIEF DESCRIPTION OF THE DRAWINGS

FIG. 1 is a schematic representation of a known RFID system 10 comprising a read-write device 1 and an RFID tag 5, realised according to the prior art teachings.

FIG. 2 is a schematic representation of basic and optional opcodes according to the ISO standard.

FIG. 3 is a schematic representation of a secure RFID system 20 comprising a read-write device 1 and an RFID tag 5, realized according to the present invention.

FIG. 4 is an example of a schematic representation of a linear mapping function from a basic opcode to a crypto opcode, according to the present invention.

FIG. 5 is an example of a schematic representation of a non-linear mapping function from a basic opcode to a crypto opcode, according to the present invention.

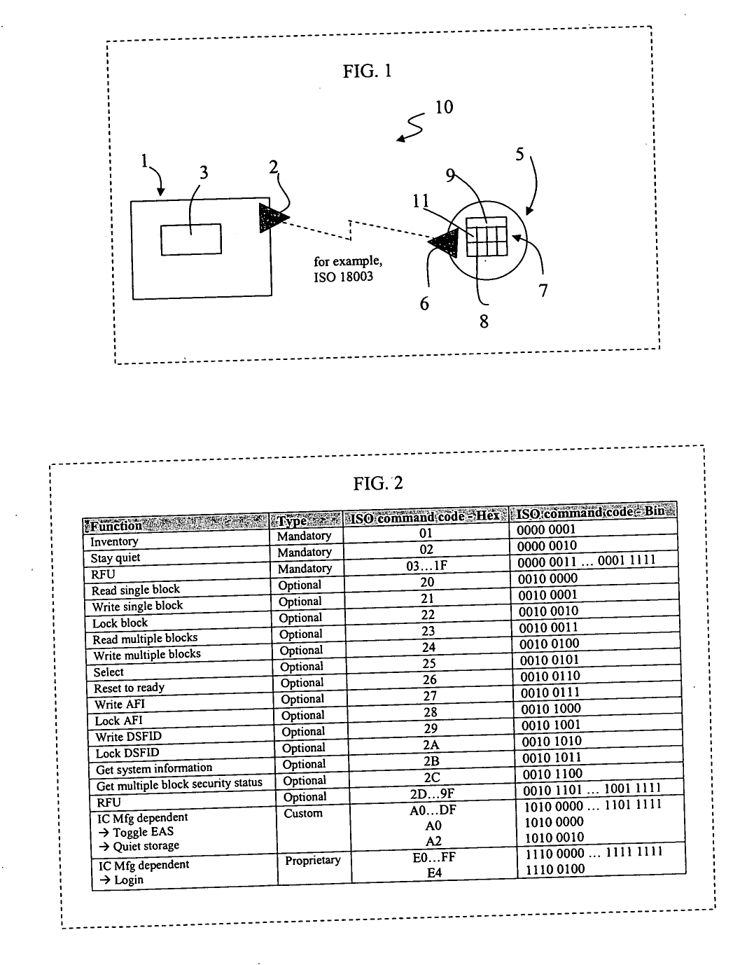

### DETAILED DESCRIPTION

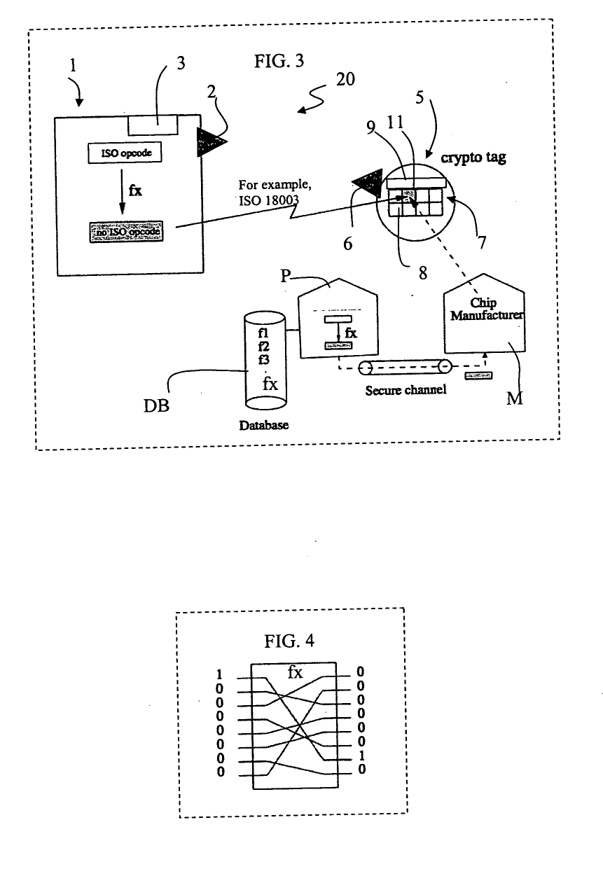

With more specific reference to FIG. 3, a secure RFID system according to a first embodiment of the present invention will now be described and globally indicated with 20.

The RFID system 20 includes a read-write device 1 comprising an antenna 2, for receiving and transmitting RF waves from lo and to an RFID tag 5.

Such a read-write device 1 includes a memory unit 3 storing a plurality of basic opcodes ba-op.

The RFID tag 5 comprises a tag antenna 6 and a microchip 7, including a memory unit 8 and an electronic processing unit 9; the memory unit 8 stores a plurality of opcodes cr-op for driving the communication between the read-write device 1 and data associated to an item to be tagged.

More particularly, the RFID tag 5 is activated by a magnetic field generated by the read-write device 1 and joining with the tag-antenna 6 on the RFID tag 5.

According to the present invention, the opcodes cr-op stored inside the memory unit 8 are in a private or crypto form, derived from a transformation of the standard ISO basic opcodes ba-op.

More particularly, the opcodes cr-op are provided in a crypted form, and hereinafter referred as the crypto opcodes cr-op. The crypto opcodes may be hardwired.

Those crypto opcodes cr-op are derived from the basic opcodes ba-op through a mapping function fx provided by a service security provider P. The mapping function fx may also provide a mapping from a plurality of standard optional opcodes opt-op to a plurality of crypto optional opcodes opt-cr-op.

The mapping function fx is stored in a database DB managed by the service security provider P and is uniquely associated to a specified customer C that requires to tag its items in a secure way.

The crypto operands cr-op are sent, via a secure channel, to a processor manufacturer M that write them in one or more memory block 12 of the memory unit 8.

Advantageously, the service security provider P associates, a proprietary mapping function fx to a corresponding customer C, so that all the RFID tags 5 used by the customer C are programmed with crypto opcodes cr-op private to the customer C.

Also the read-write device 1, intended to the customer C is programmed through the mapping function fx so that the ISO basic opcodes ba-op are mapped into corresponding crypto opcodes cr-op and stored inside the device memory 3, before being transmitted to the RFID tag 5.

The RFID tag 5, programmed with crypto opcodes cr-op and crypto optional opcodes opt-cr-op, communicates only with a specific customer C, provided with a read-write device 1 that is programmed with a mapping function fx able to derive basic opcodes ba-op into corresponding crypto opcodes cr-op.

Otherwise, if the memory unit 8 of the RFID tag 5 is not programmed to store crypto opcodes cr-op specifically associated to a mapping function fx of the read-write device 1, there is no way to access its data.

Only a read-write device 1 with the knowledge of the specific mapping function fx, associated to a specific customer C, would be able to read the UID of an RFID tag 5 programmed with crypto opcodes cr-op previously disclosed.

The opcodes cr-op stored inside the memory unit 8 may also be re-programmed to communicate with a read-write device 1 provided with a mapping function fz. Also the read-write device 1 may be re-programmed, replacing a mapping function fx with a new mapping function fz able to read a new set of RFID tag 5. The mapping function fx may be implemented in different modality. The simpler mapping function fx is a linear permutation wherein the positions of the different bits in the opcode are simply rearranged. FIG. 4 schematically represent an example of a linear permutation mapping function fx (linear mapping).

Anyway, a linear mapping function fx might be a weak protection because a trick message, formed by a single first bit having the “1”, value at the input followed by a remaining group of bits having “0” value would easily reveal one of the internal mapping, as schematically represented in FIG. 4.

In fact, transmitting a sequence of such trick messages and moving the single bit with the “1” value in each transmission, each of the connections from input to output would be revealed.

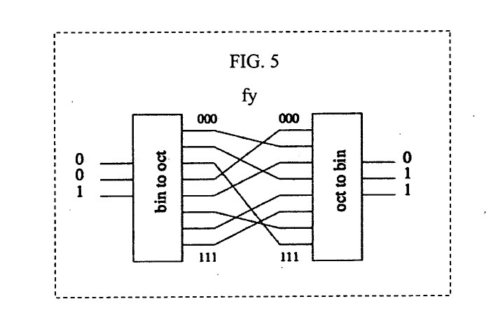

Stronger and more secure mapping functions fy, based on substitution encryption technique such as the Caesar cipher, may be adopted. FIG. 5 schematically shows one example for providing a greater crypto complexity through the use of a non-linear mapping function fy.

In general, n input bits are first represented as one of 2ⁿ different characters. The sets of 2ⁿ characters are then permuted so that each character is transposed to one of the others in the set. The character is then converted back to an n-bit output. In this particular non-linear transformation there are (2ⁿ)! different substitution or connection patterns possible.

With a non-linear mapping fy a good protection for the RFID system 20 is reached, without increasing the RFID system complexity, keeping the same reading speed of the read-write device 1 and the same computational power of the RFID tag 5.

In general, there are several ways to create non-linear mapping functions, which can de-motivate a hacker to copy the code of a specific transponder.

According to the present invention, the data associated to an RFID tag 5 and stored inside the memory unit 8 may be accessed only by a read-write device 1 programmed to compute crypted opcodes cr-op.

Advantageously, the crypto opcode cr-op sent by the read-write device 1 is interpreted successfully by the RFID tag 5 only if the mapping function fx, used to compute the crypto opcodes cr-op inside the read-write device 1, is the same mapping function fx used by the manufacturer M to store the crypto opcodes cr-op inside the memory unit 8 of the RFID tag 5.

In another embodiment of the present invention the RFID tag 5 is directly activated by an on board power and not by the magnetic field generated by the read-write device 1. Also in this case, the opcodes cr-op stored inside the memory unit 8 are in a private or crypto form, derived from a transformation of the standard ISO basic opcodes ba-op. Even if the RFID tag 5 is powered on, no data can be read when its memory unit 8 does not store crypto opcodes cr-op specifically intended to communicate with a corresponding read-write device 1.

The RFID system according to the present invention is able to protect the communication between the read-write device and a low-cost RFID tag, equipped with small storage capacity and low computational power.

The RFID system of the invention complies with the standard ISO and, at the same time, is able to guarantee security preserving the reading speed of the read-write device, without overcharging the RFID tag with computationally intensive and advanced cryptographic operations.

1. Radio frequency identification (RFID) system comprising:
a read-write device (1), including a memory unit (3) for storing a plurality of basic operating codes (ba-op);
an RFID tag (5), including a memory unit (8) for storing data item and a plurality of further operating codes (cr-op);
said basic operating codes (ba-op) and said further opcodes (cr-op) driving the communication between said read-write device (1) and said RFID tag (5) according to a standard air interface, characterized in that:
said memory unit (3) comprises a mapping function (fx) for transforming said basic operating codes (ba-op) in said further operating codes (cr-op).

2. Radio frequency identification (RFID) system according to claim 1 characterized by the fact that said further operating codes (cr-op) are in crypted format.

3. Radio frequency identification (RFID) system according to claim 1 characterized by the fact that:
said memory unit (3) also comprises a plurality of optional operating codes (opt-op);
said memory unit (8) also comprises a plurality of further optional operating codes (opt-cr-op);
being said mapping function (fx) able to transform said optional operating codes (opt-op) into said further optional operating codes (opt-cr-op).

4. Radio frequency identification (RFID) system according to claim 3 characterized by the fact that said further optional operating codes (opt-cr-op) are in crypted format.

5. Radio frequency identification (RFID) system according to claim 1 characterized by the fact that the communication between said RFID tag (5) and said read-write device (1) is authorised through said mapping function (fx).

6. Radio frequency identification (RFID) system according to claim 1 characterized by the fact that said mapping function (fx) is stored in a secure database (DB).

7. Radio frequency identification (RFID) system according to claim 1 characterized by the fact that a server security provider (P) provides the storing of said mapping function (fx) into said memory unit (3).

8. Radio frequency identification (RFID) system according to claim 7 characterized by the fact that said server security provider (P) communicates, via a secure channel, said further operating codes (cr-op) to a processor manufacturer (M).

9. Radio frequency identification (RFID) system according to claim 8 characterized by the fact that said processor manufacturer (M) write inside said memory unit (8) said further operating codes (cr-op) in crypted format.

10. Radio frequency identification (RFID) system according to claim 1 characterized by the fact that said RFID tag (5) is activated by a magnetic field generated by said read-write device (1) and joining with a tag-antenna (6) on the RFID tag (5).

11. Radio frequency identification (RFID) system according to claim 1 characterized by the fact that said RFID tag (5) comprises an on board power.

12. Method for driving a secure communication in a radio frequency identification (RFID) system between a read-write device (1) and an RFID tag (5) comprising the step of:
storing inside a memory unit (3) of said read-write device (1), a plurality of basic operating codes (ba-op);
storing inside a memory unit (8) of said RFID tag (5) a plurality of further operating codes (cr-op);
driving said communication through said basic operating codes (ba-op) and said further opcodes (cr-op), characterized in comprising the step of:
storing inside said memory unit (3) a mapping function (fx) for transforming said basic operating codes (ba-op) into said further operating codes (cr-op).

13. Method according to claim 12 characterized by the fact of storing in crypted format said plurality of further operating codes (cr-op) inside said memory unit (8).

14. Method according to claim 12 characterized by comprising the step of:
storing inside said memory unit (3) a plurality of optional operating codes (opt-op);
storing inside said memory unit (8) a plurality of further optional operating codes (opt-cr-op);
driving said communication through said plurality of optional operating codes (opt-op) and said further optional opcodes (opt-cr-op)
transforming said optional operating codes (opt-op) into said further optional operating codes (opt-cr-op) through said mapping function (fx).

15. Method according to claim 12 characterized by the step of storing in crypted format said further optional operating codes (opt-cr-op) inside said memory unit (8).

16. Method according to claim 12 characterized by the step of authorizing said communication between said RFID tag (5) and said read-write device (1) through said, mapping function (fx).

17. Method according to claim 12 characterized by the step of storing said mapping functions (fx) in a secure database (DB).

18. Method according to claim 17 characterized by the step of authorizing a server security provider (P) to access said secure database (DB).

19. Method according to claim 18 characterized by the step of storing said mapping function (fx) provided by said server security provider (P) into said memory unit (3).

20. Method according to claim 18 characterized by the step of communicating, via a secure channel, said further operating codes (cr-op) from said server security provider (P) to a processor manufacturer (M).

21. Method according to claim 20 characterized by the step of storing said further operating codes (cr-op) in crypted format inside said memory unit (8).
